(19) United States
(12) Patent Application Publication
(10) Pub. No.: US 2020/0341322 A1
(43) Pub. Date: Oct. 29, 2020

(54) DISPLAY PANEL

(71) Applicant: HKC Corporation Limited, Shenzhen City (CN)

(72) Inventor: JianFeng Shan, Shenzhen City (CN)

(21) Appl. No.: 16/955,588

(22) PCT Filed: Sep. 11, 2018
(86) PCT No.: PCT/CN2018/105077

§ 371 Date: Jun. 18, 2020

(30) Foreign Application Priority Data
Dec. 21, 2017 (CN) 201711393078.4

(51) Int. Cl. G02F 1/1345; G02F 1/1339; G02F 1/1335

(52) U.S. Cl. CPC G02F 1/13454; G02F 1/133514; G02F 1/1339

(57) ABSTRACT

A display panel is provided, including: an active switch array substrate, a counter substrate disposed opposite to the active switch array substrate, a sealant disposed between the active switch array substrate and the counter substrate, and located in the peripheral region to form an accommodating space with the active switch array substrate and the counter substrate, a display medium layer located in the accommodating space, a gate driver on array circuit disposed on the peripheral region of the active switch array substrate, and located in the accommodating space, and an isolating member disposed between the active switch array substrate and the counter substrate. The active switch array substrate includes a display region and a peripheral region surrounding the display region. The isolating member is configured for separating the display medium layer from the gate driver on array in the accommodating space.

### FIELD OF THE DISCLOSURE

The disclosure relates to a display technical field, and more particularly to a display panel.

### BACKGROUND

The processing architecture of display panels can be classified into two kinds according to the design of gate driver. One is the system on chip (SOC) and the other is gate driver on array (GOA). The SOC is realized via attaching the integrated chips to the gate driver. The gate driver of GOA is achieved through disposing a gate driver circuit between the array substrate and the color filter substrate of a display panel. Compared with the SOC design, the GOA can narrow the frame with lower costs, and GOA products are the mainstream trends in the future. In a GOA-type liquid crystal display panel of an exemplary technology, liquid crystal molecules are fully filled in between a gate driver circuit of the GOA-type liquid crystal display panel and a common electrode of a liquid crystal display panel. As the gate driver circuit of the GOA-type liquid crystal display panel includes an active switch thin film transistor (TFT). Capacitance will be generated between the TFT and the common electrode, resulting in overload of capacitance on resistance generated on the gate driver circuit, and the energy will be excessively consumed.

### SUMMARY

Therefore, embodiments of the disclosure provide a display panel capable of effectively reducing the capacitance load on resist generated on a gate driver on array circuit.

The disclosure provides a display panel, including: an active switch array substrate, a counter substrate disposed opposite to the active switch array substrate, a sealant disposed between the active switch array substrate and the counter substrate and located in the peripheral region, a display medium layer disposed between the active switch array substrate and the counter substrate and located in the accommodating space, a gate driver on array circuit disposed in the peripheral region of the active switch array substrate and located in the accommodating space, and an isolating member disposed between the active switch array substrate and the counter substrate. The active switch array substrate includes a display region and a peripheral region surrounding the display region. The sealant cooperative with the active switch array substrate and the counter substrate form an accommodating space. The isolating member is configured for separating the display medium layer from the gate driver on array circuit in the accommodating space.

In an embodiment of the disclosure, the isolating member is disposed covering the gate driver on array circuit, and the isolating member and the sealant are a one-piece structure.

In an embodiment of the disclosure, the isolating member is located at two opposite sides of the display region.

In an embodiment of the disclosure, the isolating member in the accommodating space divides the accommodating space into a first space at an inner side of the isolating member and a second space between the isolating member and sealant. The display region and the display medium layer are located in the first space. The gate driver on array circuit is located in the second space.

In an embodiment of the disclosure, the isolating member is a ring-shaped structure surrounding the display region.

In an embodiment of the disclosure, the isolating member includes strip-shaped structures located between the display region and the gate driver on array circuits.

In an embodiment of the disclosure, the strip-shaped structures of the isolating member are located at two opposite sides of the display region.

In an embodiment of the disclosure, the active switch array substrate further includes a signal transmission bus, located at a side of the gate driver on array circuit facing away from the display region.

In an embodiment of the disclosure, the display panel further includes a source driver chip, disposed in the peripheral region of the active switch array substrate and located at a side of the display region without the gate drivers on array circuit.

In an embodiment of the disclosure, the display medium layer is a liquid crystal layer.

The disclosure further provides another display panel, including: an active switch array substrate, a counter substrate disposed opposite to the active switch array substrate, a sealant disposed between the active switch array substrate and the counter substrate and located in the peripheral region, a display medium layer disposed between the active switch array substrate and the counter substrate and located in the accommodating space, a gate driver on array circuit disposed in the peripheral region of the active switch array substrate, and located in the accommodating space, and an isolating member disposed between the active switch array substrate and the counter substrate. The active switch array substrate includes a display region and a peripheral region surrounding the display region. The sealant cooperative with the active switch array substrate and the counter substrate form an accommodating space. The isolating member is configured for separating the display medium layer from the gate driver on array in the accommodating space. The active switch array substrate further includes a signal transmission bus, located at a side of the gate driver on array circuit facing away from the display region; the display panel further includes a source driver chip disposed in the peripheral region of the active switch array substrate and located at a side of the display region without the gate driver on array circuit.

According to the embodiments of the disclosure, the isolating member disposed between the active switch array substrate and the counter substrate can isolate the display medium layer from the gate driver on array circuit in the accommodating space for effectively reducing the capacitance load on resist generated on a gate driver on array circuit.

### BRIEF DESCRIPTION OF THE DRAWINGS

In order to clearly illustrate embodiments of the disclosure, accompanying drawings necessary for describing the embodiments will be briefly introduced. Apparently, the drawings in the description below are merely some embodiments of the disclosure, and a person skilled in the art can obtain other drawings according to these drawings without creative efforts.

FIG. 1A is a structural schematic view of a display panel according to an embodiment of the disclosure;

FIG. 1B is a structural schematic view of the display panel taken along a dashed line A in FIG. 1A;

FIG. 2A is a structural schematic view of a display panel according to another embodiment of the disclosure;

FIG. 2B is a structural schematic view of the display panel taken along a line B in FIG. 2A;

FIG. 3A is a structural schematic view of a display panel according to still another embodiment of the disclosure;

FIG. 3B is a structural schematic view of the display panel taken along a line C in FIG. 3A.

### DETAILED DESCRIPTION OF PREFERRED EMBODIMENTS

Embodiments of the disclosure will be clearly illustrated with reference to the accompanying drawings. Apparently, the described embodiments herein are some but not all of the embodiments. To a person skilled in the art, all the other embodiments based on the embodiments in the disclosure without any creativity belong to the protective scope of the disclosure.

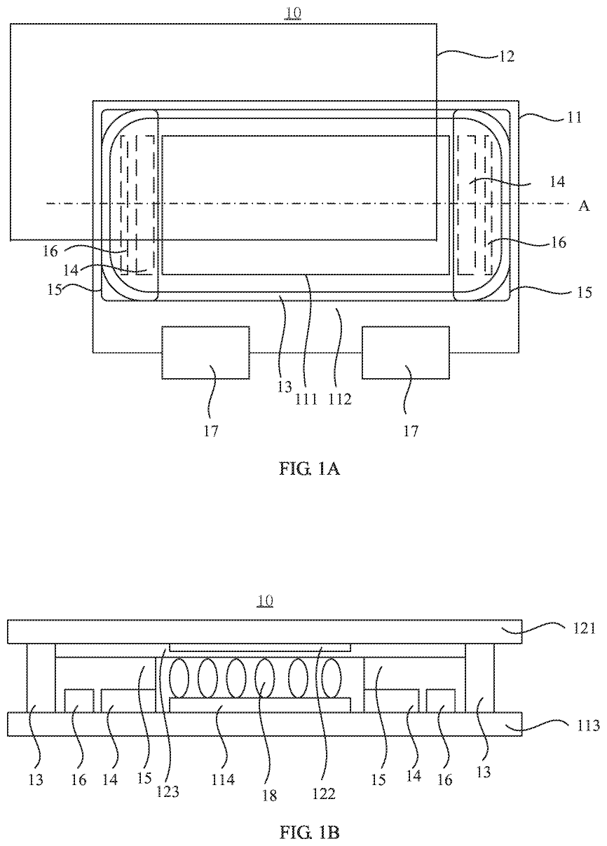

FIG. 1A is a display panel 10 according to an embodiment of the disclosure, primarily including: an active switch array substrate 11, a counter substrate 12, a sealant 13, gate driver on array (GOA) circuits 14, isolating members 15, signal transmission buses 16 and source driver chips 17. The active switch array substrate 11 includes a display region 111 and a peripheral region 112 surrounding the display region 111; the counter substrate 12 is disposed opposite to the active switch array substrate 11. To be more specific, an area of the counter substrate 12 can be smaller than an area of the active switch array substrate 11. The counter substrate 12 can be disposed parallel to the active switch array substrate 11. The projection of the counter substrate 12 on the active switch array substrate 11 in a direction perpendicular to the active switch array substrate 11 is contained in the active switch array substrate 11 to admit a portion of elements of the display panel 10 disposed on the active switch array substrate 11 such as the source driver chips 17 to be uncovered with the counter substrate 12; the sealant 13 can be made of an opaque material, and disposed between the active switch array substrate 11 and the counter substrate 12. The sealant 13 can be configured for adhering the active switch array substrate 11 and the counter substrate 12. The sealant 13 can be located in the peripheral region 112 to form an accommodating space with the active switch array substrate 11 and the counter substrate 12; the gate driver on array circuits 14 are disposed on the peripheral region 112 of the active switch array substrate 11 and located in the accommodating space; the isolating members 15 are disposed between the active switch array substrate 11 and the counter substrate 12; the signal transmission bus 16 is located on a side of the gate driver on array circuits 14 facing away from the display region 111; the source driver chips 17 are disposed in the peripheral region 112 of the active switch array substrate 11 and located at a side of the display region 111 without the gate driver on array circuits 14 (i.e. the gate driver on array circuits 14 are severally disposed on the left side and the right side of the display region 111 as shown in the bottom of FIG. 1A); the signal transmission bus 16 can be connected with the gate driver on array circuit 14 for providing a clock signal, therefore the signal transmission buses 16 can be disposed in pair with the gate driver on array circuits 14 on two opposite sides of the display region 111.

FIG. 1B is a local structural schematic view of the display panel 10 taken along a dashed line A in FIG. 1A. The display panel 10 can further include a display medium layer 18. The active switch array substrate 11 can further include a base 113, a pixel electrode 114 disposed on the base 113 and an active switch such as a TFT not shown in the figure. The counter substrate 12 can include a base 121, a color filter 122 and a common electrode 123. The display medium layer 18 can be disposed between the active switch array substrate 11 and the counter substrate 12, and located in the accommodating space; the sealant 13 can be disposed to surround the display medium layer 18 to seal composition matters of the display medium layer 18 in a certain region; the isolating member 15 is configured for separating the display medium layer 18 from the gate driver on array circuit 14 in the accommodating space. To be more specific, the base 113 and the base 121 can both be made of transparent glass or transparent plastic; the pixel electrode 114 can include numerous sub-pixel electrodes. The pixel electrode 114 can be made of a transparent conductive metal material. The transparent conductive metal material can be an indium tin oxide (ITO) thin film material. The ITO thin film has high conductivity, high light transmittance, high mechanical hardness and superior chemical stability; the display medium layer 18 can be a liquid crystal layer consisting of liquid crystal molecules; the isolating members 15 can be made of an opaque material identical to the sealant 13. The isolating members 15 can cover the gate driver on array circuits 14 and the bus transmission bus 16 to permit the isolating members 15 to fully fill the space between the gate driver on array circuits 14 and the common electrode 123 for insulating the display medium layer 18 from the gate driver on array circuits 14. Furthermore, the isolating member 15 and the sealant 13 can be an integral structure. The integral structure is the integral formation of the isolating member 15 and the sealant 13; the number of the gate driver on array circuits 14 can be two, and the two gate driver on array circuits 14 can be disposed on two opposite sides of the display region 111, such as the left side and the right side in FIG. 1A, and the number of isolating members 15 can be two as well. The two isolating members 15 can be disposed on two opposite sides of the display region 111. According to the requirement, the number of the gate driver on array circuits 14 can be one or two, but the embodiment of the disclosure will not be limited as such; simultaneously, the color filter 122 is for example not restricted to be disposed on the counter substrate 12 in FIG. 1A and FIG. 1B. The color filter 122 can further be disposed on the active switch array substrate 11 to form a color on TFT array (COT) type display panel; the active switch array substrate 11 and the counter substrate 12 can be disposed with black opaque materials to prevent light leaked from the display panel 10 depending on the requirement; the color filter 122 can be prepared with color photoresist blocks. The color photoresist blocks can include a red photoresist block, a green photoresist block and a blue photoresist block disposed correspondingly to each of the sub-pixel electrodes for implementing color display effects of the display panel 10; the color filter 122 can be disposed opposite to the pixel electrode 114 on the active switch array substrate 11. The color filter 122 can be disposed between the base 121 and the common electrode 123; the common electrode 123 can be made of the transparent conductive metal material identical to the pixel electrode 114. The transparent conductive metal material can be the ITO thin film material. The common electrode 123 and the pixel electrode 114 collaboratively perform to form the electric field to motivate the component in the display medium layer 18 such as liquid crystal molecules disposed between the common electrode 123 and the pixel electrode 114 to rotate for displaying images; the common electrode 123, the color filter 122 and the pixel electrode 114 can be located in the accommodating space formed by the sealant 13, the active switch array substrate 11 and the counter substrate 12.

The gate driver on array circuit, the counter substrate and the interposed material between the gate driver on array circuit and the counter substrate can form parallel capacitances. The formula of the parallel capacitances is C=ε₀εᵣA/d, where co is a permittivity in the vacuum, εᵣ is a permittivity of the interposed material, A and d both are constants. According to the formula, the capacitance is directly proportional to the permittivity of the interposed material. The permittivity of the display medium such as liquid crystal molecules will be various with respect to different materials, and the maximal value proximately is 7.

According to the previous embodiment of the disclosure, the isolating members 15 can be disposed to fully cover the gate driver on array circuits 14 for separating the display medium layer 18 from the gate driver on array circuits 14 in the accommodating space. As the isolating members 15 generally are made of the same material as the sealant 13, the permittivity is between 3 and 4. The permittivity of the isolating members 15 is smaller than the permittivity of the display medium layer 18 such as liquid crystal molecules. The previous embodiment of the disclosure consequently can generate the smaller capacitance compared with bestrewing the gate driver on array circuits 14 with the display medium layer 18 such as liquid crystal molecules, so as to effectively reduce the capacitance value of the gate driver on array circuits.

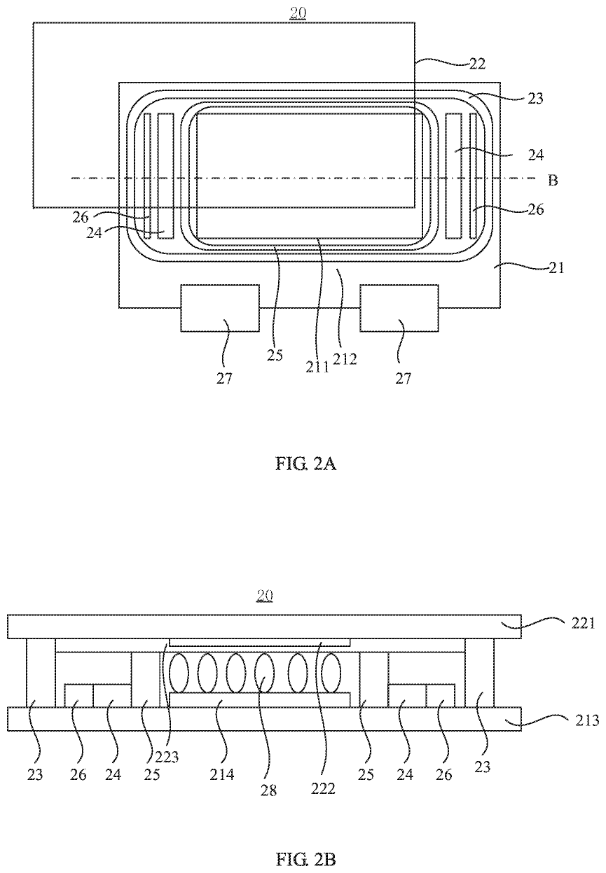

FIG. 2A is a display panel 20 according to another embodiment of the disclosure, primarily including an active switch array substrate 21, a counter substrate 22, a sealant 23, gate driver on array circuits 24, an isolating member 25, signal transmission buses 26 and source driver chips 27. The active switch array substrate 21 includes a display region 211 and a peripheral region 212 surrounding the display region 211; the counter substrate 22 is disposed opposite to the active switch array substrate 21. To be more specific, an area of the counter substrate 22 can be smaller than an area of the active switch array substrate 21. The counter substrate 22 can be disposed parallel to the active switch array substrate 21. The projection of the counter substrate 22 on the active switch array substrate 21 in a direction perpendicular to the active switch array substrate 21 is contained in the active switch array substrate 21 to admit a portion of elements of the display panel 20 disposed on the active switch array substrate 21 such as the source driver chips 27 to be uncovered with the counter substrate 22; the sealant 23 can be made of an opaque material, and disposed between the active switch array substrate 21 and the counter substrate 22. The sealant 23 can be configured for adhering the active switch array substrate 21 and the counter substrate 22. The sealant 23 can be located in the peripheral region 212 to form an accommodating space with the active switch array substrate 21 and the counter substrate 22; the gate driver on array circuits 24 are disposed on the peripheral region 212 of the active switch array substrate 21 and located in the accommodating space; the isolating member 25 is disposed between the active switch array substrate 21 and the counter substrate 22; the signal transmission bus 26 is located at a side of the gate driver on array circuits 24 facing away from the display region 211; the source driver chips 27 are disposed in the peripheral region 212 of the active switch array substrate 21 and located at a side of the display region 211 without the gate driver on array circuits 24 (i.e. the gate driver on array circuits 24 are severally disposed on the left side and the right side of the display region 211 as shown in the bottom of FIG. 2A); the signal transmission bus 26 can be connected with the gate driver on array circuit 24 for providing a clock signal, therefore the signal transmission buses 26 can be disposed in pair with the gate driver on array circuits 24 on two opposite sides of the display region 211.

FIG. 2B is a local structural schematic view of the display panel 20 taken along a dashed line B in FIG. 2A. The display panel 20 can further include a display medium layer 28. The active switch array substrate 21 can further include a base 213, a pixel electrode 214 disposed on the base 213 and an active switch such as a TFT not shown in the figure. The counter substrate 22 can include a base 221, a color filter 222 and a common electrode 223. The display medium layer 28 can be disposed between the active switch array substrate 21 and the counter substrate 22, and located in the accommodating space; the sealant 23 can be disposed to surround the display medium layer 28 to seal composition matters of the display medium layer 28 in a certain region; the isolating member 25 is configured for separating the display medium layer 28 from the gate driver on array circuit 24 in the accommodating space. To be more specific, the base 213 and the base 221 can both be made of transparent glass or transparent plastic; the pixel electrode 214 can include numerous sub-pixel electrodes. The pixel electrode 214 can be made of a transparent conductive metal material. The transparent conductive metal material can be an indium tin oxide (ITO) thin film material; the display medium layer 28 can be a liquid crystal layer consisting of liquid crystal molecules; the isolating member 25 can be located in the accommodating space for dividing the accommodating space into a first space at an inner side of the isolating member 25 and a second space located between the isolating member 25 and the sealant 23. The display region 211 and the display medium layer 28 located at the display region 211 are in the first space. The gate driver on array circuits 24 and the signal transmission buses 26 are located in the second space. To be more specific, the isolating member 25 can be a ring-shaped structure disposed around the display region 211, identically to the sealant 23 disposed to surround the display region 211 and the display medium layer 28 on the display region 211 for separating the composition matters of the display medium layer 28 such as liquid crystal molecules in the first space from the gate driver on array circuits 24 and the signal transmission buses 26 in the second space. The isolating member 25 can be made of the same material as the sealant 23 for adhering the base 213 and the common electrode 223 on the base 221; the number of the gate driver on array circuits 24 can be two, and the two gate driver on array circuits 24 can be disposed on two opposite sides of the display region 211, such as the left side and the right side in FIG. 2A. The number of the gate driver on array circuit 24 can be one or two, but the embodiment of the disclosure will not be limited as such; simultaneously, the color filter 222 is for example not restricted to be disposed on the counter substrate 22 in FIG. 2A and FIG. 2B. The color filter 222 can further be disposed on the active switch array substrate 21 to form a COT type display panel; the active switch array substrate 21 and the counter substrate 22 can be disposed with black opaque materials to prevent light leaked from the display panel 20 depending on the requirement; the color filter 222 can be prepared with color photoresist blocks. The color photoresist blocks can include a red photoresist block, a green photoresist block and a blue photoresist block disposed correspondingly to each of the sub-pixel electrodes for implementing color display effects of the display panel 20; the color filter 222 can be disposed opposite to the pixel electrode 214 on the active switch array substrate 21. The color filter 222 can be disposed between the base 221 and the common electrode 223; the common electrode 223 can be made of the transparent conductive metal material identical to the pixel electrode 214. The transparent conductive metal material can be the ITO thin film material. The common electrode 223 and the pixel electrode 214 collaboratively perform to form the electric field to motivate the component in the display medium layer 28 such as liquid crystal molecules disposed between the common electrode 223 and the pixel electrode 214 to rotate for displaying images; the common electrode 223, the color filter 222 and the pixel electrode 214 can be located in the accommodating space formed by the sealant 23, the active switch array substrate 21 and the counter substrate 22.

Summarily, according to the embodiments of the disclosure above, the isolating member 25 is disposed to be the ring-shaped structure located between the display region 211 and the gate driver on array circuits 24 to allow the space between the gate driver on array circuits 24 and the common electrode 223 to be vacuum for the purpose of insulating the display medium layer 28 from the gate driver on array circuits 24 in the accommodating space. As the permittivity in the vacuum is 1 and the permittivity is lower than the permittivity of the display medium layer 28 such as liquid crystal molecules, the previous embodiments of the disclosure consequently can generate the smaller capacitance compared with bestrewing the gate driver on array circuit 24 with the display medium layer 28 such as liquid crystal molecules, so as to effectively reduce the capacitance value of the gate driver on array circuits.

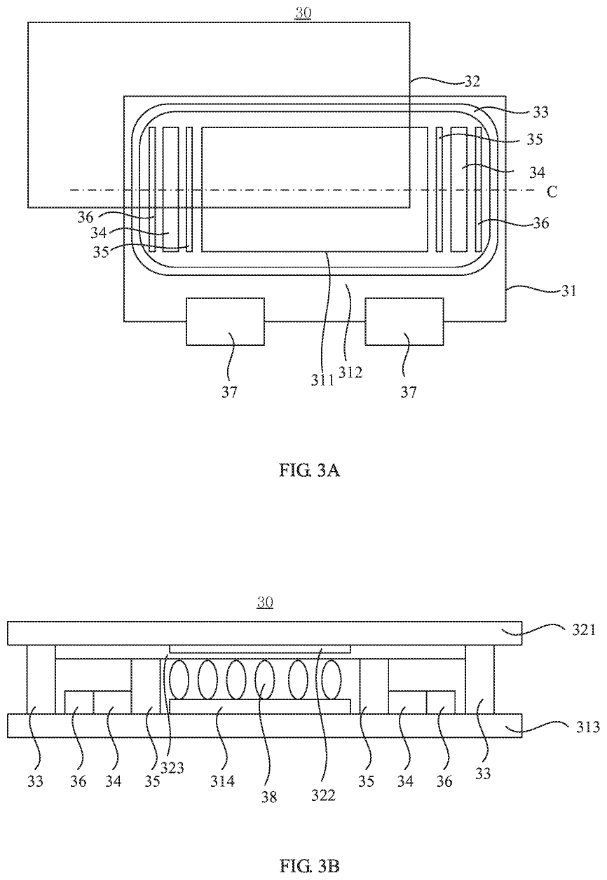

FIG. 3A is a display panel 30 according to still another embodiment of the disclosure, primarily including: an active switch array substrate 31, a counter substrate 32, a sealant 33, gate driver on array circuits 34, isolating members 35, signal transmission buses 36 and source driver chips 37. The active switch array substrate 31 includes a display region 311 and a peripheral region 312 surrounding the display region 311; the counter substrate 32 is disposed opposite to the active switch array substrate 31. To be more specific, an area of the counter substrate 32 can be smaller than an area of the active switch array substrate 31. The counter substrate 32 can be disposed parallel to the active switch array substrate 31. The projection of the counter substrate 32 on the active switch array substrate 31 in a direction perpendicular to the active switch array substrate 31 is contained in the active switch array substrate 31 to admit a portion of elements of the display panel 30 disposed on the active switch array substrate 31 such as the source driver chips 37 to be uncovered with the counter substrate 32; the sealant 33 can be made of an opaque material, and disposed between the active switch array substrate 31 and the counter substrate 32. The sealant 33 can be configured for adhering the active switch array substrate 31 and the counter substrate 32. The sealant 33 can be located in the peripheral region 312 to form an accommodating space with the active switch array substrate 31 and the counter substrate 32; the gate driver on array circuits 34 are disposed on the peripheral region 312 of the active switch array substrate 31 and located in the accommodating space; the isolating members 35 are disposed between the active switch array substrate 31 and the counter substrate 32; the signal transmission bus 36 is located on a side of the gate driver on array circuit 34 facing away from the display region 311; the source driver chips 37 are disposed in the peripheral region 312 of the active switch array substrate 31 and located on a side of the display region 311 without the gate driver on array circuits 34 (i.e. the gate driver on array circuits 34 are severally disposed on the left side and the right side of the display region 311 as shown in the bottom of FIG. 3A); the signal transmission bus 36 can be connected with the gate driver on array circuit 34 for providing a clock signal, therefore the signal transmission buses 36 can be disposed in pair with the gate driver on array circuits 34 on two opposite sides of the display region 311.

FIG. 3B is a local structural schematic view of the display panel 30 taken along a dashed line C in FIG. 3A. The display panel 30 can further include a display medium layer 38. The active switch array substrate 31 can further include a base 313, a pixel electrode 314 disposed on the base 313 and an active switch such as a TFT not shown in the figure. The counter substrate 32 can include a base 321, a color filter 322 and a common electrode 323. The display medium layer 38 can be disposed between the active switch array substrate 31 and the counter substrate 32, and located in the accommodating space; the sealant 33 can be disposed to surround the display medium layer 38 to seal composition matters of the display medium layer 38 within a certain region; the isolating member 35 is configured for separating the display medium layer 38 from the gate driver on array circuit 34 in the accommodating space. To be more specific, the base 313 and the base 321 can both be made of transparent glass or transparent plastic; the pixel electrode 314 can include numerous sub-pixel electrodes. The pixel electrode 314 can be made of a transparent conductive metal material. The transparent conductive metal material can be an ITO thin film material; the display medium layer 38 can be a liquid crystal layer consisting of liquid crystal molecules; the isolating members 35 can be made of an opaque material identical to the sealant 33. The isolating members 35 can be strip-shaped structures located between the display region 311 and the gate driver on array circuits 34; the number of the gate driver on array circuits 34 can be two, and the two gate driver on array circuits 34 can be disposed on two opposite sides of the display region 311, such as the left side and the right side in FIG. 3A, and the number of isolating members 35 can be two as well. The two isolating members 35 can be two strip-shaped structures disposed on two opposite sides of the display region 311 respectively. According to the requirement, the number of the gate driver on array circuits 34 can be one or two, but the embodiment of the disclosure will not be limited as such; simultaneously, the color filter 322 is for example not restricted to be disposed on the counter substrate 32 in FIG. 3A and FIG. 3B. The color filter 322 can further be disposed on the active switch array substrate 31 to form a COT type display panel; the active switch array substrate 31 and the counter substrate 32 can be disposed with black opaque materials to prevent light leaked from the display panel 30 depending on the requirement; the color filter 322 can be prepared with color photoresist blocks. The color photoresist blocks can include a red photoresist block, a green photoresist block and a blue photoresist block disposed correspondingly to each of the sub-pixel electrodes for implementing color display effects of the display panel 30; the color filter 322 can be disposed opposite to the pixel electrode 314 on the active switch array substrate 31. The color filter 322 can be disposed between the base 321 and the common electrode 323; the common electrode 323 can be made of the transparent conductive metal material identical to the pixel electrode 314. The transparent conductive metal material can be the ITO thin film material. The common electrode 323 and the pixel electrode 314 collaboratively perform to form the electric field to motivate the component in the display medium layer 38 such as liquid crystal molecules disposed between the common electrode 323 and the pixel electrode 314 to rotate for displaying images; the common electrode 323, the color filter 322 and the pixel electrode 314 can be located in the accommodating space formed by the sealant 33, the active switch array substrate 31 and the counter substrate 32.

In some embodiments, the display panel 30 can be a liquid crystal display panel, an organic light emitting diode (OLED) display panel, a quantum dot light emitting diode (QLED) display panel, a curved display panel or other display panels. The display control layer can be a liquid crystal layer. An organic light emitting layer or other display control layers will be limited herein.

Summarily, according to the embodiment of the disclosure above, the isolating members 35 are disposed to be the strip structures located between the display region 311 and the gate driver on array circuits 34 to allow the space between the gate driver on array circuits 34 and the common electrode 323 to be vacuum for the purpose of insulating the display medium layer 38 from the gate driver on array circuits 34 in the accommodating space. As the permittivity in the vacuum is 1 and the permittivity is lower than the permittivity of the display medium layer 38 such as liquid crystal molecules, the previous embodiments of the disclosure consequently can generate the smaller capacitance compared with bestrewing the gate driver on array circuit 34 with the display medium layer 38 such as liquid crystal molecules, so as to effectively reduce the capacitance value of the gate driver on array circuits.

In the embodiments in the disclosure, the disclosed system, devices and methods can be fulfilled in other manners. For instance, the device described in the embodiments above merely is exemplary, for example, the division is nothing but a logically functional division without excluding other divisions applied in practice. And multiple elements or modules can be combined or integrated in another system, or some features can be omitted, or skipped in execution. In addition, the mutual connection of coupling, immediately coupling or communicating in display or discussion can be indirect coupling or communicating connection through some port, device or element, electrically, mechanically or in other forms.

The parts illustrated separately can be physically discrete or not. The shown parts can be physical parts or not, located at one position, or distributed on numerous paths. Some or all of the units can be selected to chase the objective of the embodiments according to the practical requirement.

Furthermore, each of functional elements in each of the embodiments of the disclosure can be integrated in a processor, or individually distributed, or two or more than two elements are integrated in a processor. The integrated elements can be fulfilled in hardware, or hardware with software functional elements.

The final declaration is the embodiments above are merely for illustrating embodiments of the disclosure rather than any limitation; even though the disclosure is explained in detail with reference to the aforementioned embodiments, a person skilled in the art can understand the previously described embodiments can be amended, or some technical features therein can be replaced; the amendment or replacement will not result in the essence excluded from the spirit and scope of the disclosure.

What is claimed is:

1. A display panel comprising:
an active switch array substrate, comprising a display region and a peripheral region surrounding the display region;
a counter substrate, disposed opposite to the active switch array substrate;
a sealant, disposed between the active switch array substrate and the counter substrate and located in the peripheral region, wherein the sealant cooperative with the active switch array substrate and the counter substrate form an accommodating space;
a display medium layer, disposed between the active switch array substrate and the counter substrate and located in the accommodating space;
a gate driver on array circuit, disposed in the peripheral region of the active switch array substrate and located in the accommodating space;
an isolating member, disposed between the active switch array substrate and the counter substrate and configured for isolating the display medium layer from the gate driver on array circuit in the accommodating space.

2. The display panel according to claim 1, wherein the isolating member is disposed covering the gate driver on array circuit, and the isolating member and the sealant are a one-piece structure.

3. The display panel according to claim 2, wherein the isolating member is located at two opposite sides of the display region.

4. The display panel according to claim 1, wherein the isolating member in the accommodating space divides the accommodating space into a first space at an inner side of the isolating member and a second space between the isolating member and the sealant, the display region and the display medium layer are located in the first space, and the gate driver on array circuit is located in the second space.

5. The display panel according to claim 4, wherein the isolating member is a ring-shaped structure surrounding the display region.

6. The display panel according to claim 4, wherein the isolating member comprises strip-shaped structures located between the display region and the gate driver on array circuits.

7. The display panel according to claim 6, wherein the strip-shaped structures of the isolating member are located at two opposite sides of the display region.

8. The display panel according to claim 1, wherein the active switch array substrate further comprises: a signal transmission bus, located at a side of the gate driver on array circuit facing away from the display region.

9. The display panel according to claim 1, further comprising:
a source driver chip, disposed in the peripheral region of the active switch array substrate and located at a side of the display region being without the gate driver on array circuit.

10. The display panel according to claim 1, wherein the display medium layer is a liquid crystal layer.

11. The display panel according to claim 1, wherein the sealant is disposed surrounding the display medium layer to seal the display medium layer in a region.

12. The display panel according to claim 1, wherein the isolating member and the sealant are integrally formed.

13. The display panel according to claim 1, further comprising:
a source driver chip, disposed in the peripheral region of the active switch array substrate and located at a side of the display region being without the gate driver on array circuit; wherein the display medium layer is a liquid crystal layer.

14. A display panel comprising:
an active switch array substrate, comprising a display region and a peripheral region surrounding the display region;
a counter substrate, disposed opposite to the active switch array substrate;
a sealant, disposed between the active switch array substrate and the counter substrate and located in the peripheral region, wherein the sealant cooperative with the active switch array substrate and the counter substrate form an accommodating space;
a display medium layer, disposed between the active switch array substrate and the counter substrate and located in the accommodating space;
a gate driver on array circuit, disposed in the peripheral region of the active switch array substrate and located in the accommodating space;
an isolating member, disposed between the active switch array substrate and the counter substrate and configured for separating the display medium layer from the gate driver on array circuit in the accommodating space;
wherein the active switch array substrate further comprises: a signal transmission bus, located at a side of the gate driver on array circuit facing away from the display region;
wherein the display panel further comprises: a source driver chip, disposed in the peripheral region of the active switch array substrate and located at a side of the display region being without the gate driver on array circuit.

15. The display panel according to claim 14, wherein the counter substrate comprises: a base, a color filter and a common electrode; the color filter is disposed opposite to a pixel electrode on the active switch array substrate, the color filter is disposed between the base and the common electrode.

16. The display panel according to claim 15, wherein the color filter is comprises a plurality of color photoresist blocks, the color photoresist blocks comprise a red photoresist block, a green photoresist block and a blue photoresist block disposed corresponding to a plurality of sub-pixel electrodes in one-to-one manner and for achieving a color display effect of the display panel.

17. The display panel according to claim 14, wherein the active switch array substrate comprises signal transmission buses each located at a side of the gate driver on array circuit facing away from the display region.

18. The display panel according to claim 14, wherein the sealant is disposed surrounding the display medium layer to seal the display medium layer in a region.

19. The display panel according to claim 14, wherein the isolating member and the sealant are integrally formed.

20. The display panel according to claim 14, wherein the display medium layer is a liquid crystal layer.
